(19) United States
(12) Patent Application Publication
(10) Pub. No.: US 2002/0034910 A1
(43) Pub. Date: Mar. 21, 2002

(54) Material for shoe insole and lining and method of making the same

(76) Inventor: Susan Gwynneth Johnson, Botcheston (GB)

Correspondence Address: Fish & Richardson P.C., 225 Franklin Street, Boston, MA, 02110-2804, US

(21) Appl. No.: 09/750,212

(22) Filed: Dec. 28, 2000

(30) Foreign Application Priority Data
Aug. 5, 2000 (GB) 0019142.9

(51) Int. Cl. D04H 1/00; D04H 3/00; D04H 5/00; D04H 13/00; B32B 5/18; B32B 5/24

(52) U.S. Cl. 442/375; 442/327

(57) ABSTRACT

The invention provides a shoe insole or lining material comprising a non- woven base material, such as a non-woven needle felt, a liquid polymer binder, such as a water-based latex blend, and a microencapsulated phase change material dispersed within the binder, the phase change material comprising a material having reversible thermal energy storage properties, such as a hydrocarbon wax, encapsulated in microcapsules of a retaining polymer and the phase change material having an activation temperature of around body temperature.

The invention relates to a shoe insole and lining materials, principally but not exclusively to materials for maintaining the thermal climate in an enclosed shoe in hot, active or cold situations, and methods of making the same.

The term “shoe” where used herein is to be understood as denoting outer footwear generally.

A common problem with shoes is that feet can get hot in an enclosed shoe in hot or active situations. This can be uncomfortable and lead to increased sweating and increased foot odour. At the other extreme, in cold environments loss of heat from the feet can lead to a lowering of body temperature and related discomfort.

An object of the present invention is to provide a shoe insole or lining material that helps to maintain the thermal climate within the shoe more effectively than with conventional materials. A further object of the invention is to provide a method of manufacturing such a material.

The invention provides a shoe insole or lining material comprising:

a non-woven base material;

a polymer binder applied in liquid form and then solidified; and

a microencapsulated phase change material dispersed within the binder, wherein the phase change material comprises a material having reversible thermal energy storage properties encapsulated in microcapsules of a retaining polymer and the phase change material has an activation temperature of around body temperature. The base material may comprise any suitable type of insole or lining material but preferably the base material comprises a non-woven needle felt. The type of base material used depends on the required end use of the material. The term shoe insole is a broad term which includes structural insoles that are an integral part of the shoe structure and loose insoles (sometimes referred to as “insocks”) which are provided separate from the shoe structure and may be introduced into the finished shoe to modify the properties of the shoe. Loose insoles may, for example, be used to enhance the comfort of the shoe during wear e.g. by providing an enhanced cushioning effect, by slightly adjusting the fit of the shoe, by affording odour or perspiration absorbing properties, or by providing additional support for the foot (for example by providing a foot-engaging surface that is closely adapted to the foot of the wearer, such an insole commonly being referred to as a “footbed”); many of these properties might be provided, also, by a structural insole but it is common practice to provide them by loose insoles, thereby allowing the wearer to, in effect, customise an otherwise standard pair of shoes. It is convenient for any loose insole to be an insole in accordance with the invention because the loose insole will be closer to the foot of a wearer than a structural insole.

For a structural insole material the non-woven material preferably comprises a stiff, rigid board formed, for example, from a blend of polyester fibres of a range of decitex values. Alternatively for a cushion insole the non-woven material preferably comprises, for example, a blend of coarse polyester fibres having a decitex value of about 6 to give a material having a resilient and open structure.

Preferably the binder comprises a latex binder. Preferably the latex binder comprises a water based latex blend. Advantageously the latex binder comprises a stiff styrene butadiene rubber latex. Preferably the binder includes a thickener, for example ammonia and an acrylic latex that reacts with the ammonia to thicken the mixture. A particularly suitable binder comprises a blend of styrene—butadiene latices, namely 75% by weight Applied Polymers S30R and 25% by weight Synthomer™ 7050. This latex blend is preferably thickened with ammonia and an acrylic latex such as Viscalex™ HV30, manufactured by Allied Colloids.

Preferably the phase change material comprises hydrocarbon wax or paraffinic hydrocarbon encapsulated in polymer. Preferably the polymer capsules have a diameter of approximately 15 to 25 μm. In the preferred embodiment of the invention, the phase change material comprises microcapsules produced by 3M under the trade name Thermasorb™ and marketed under licence by Frisby Technologies.

The microcapsules are available in a number of different activation temperatures, this being the temperature at which they absorb heat, such that the encapsulated phase change material melts within the retaining polymer.

Preferably the melting point or activation temperature of the phase change material is in the range 15 to 55° C. (60 to 130° F.), advantageously in the range 26 to 38° C. (80 to 100° F.). For most applications the activation temperature is preferably about 28° C. (83° F.). Advantageously different grades of phase change material may be used for different applications. For example, it may be advantageous to have a higher activation temperature for shoe insoles of about 35° C. (95° F.) and a lower activation temperature of about 28° C. (83° F.) for upper or tongue areas. The variations in activation temperature can be selected to allow for the physical differences in the skin from the bottom of the foot to the top of the foot.

Preferably the microencapsulated phase change material is predispersed in water using a dispersing agent such as Dispex™ A40, before being mixed with latex binder. Preferably the phase change material is dispersed in the water at between about 30% and 60% by weight of solid material to water, preferably between 40% and 45%.

Preferably the water/microencapsulated phase change material mixture is mixed with the latex binder to give a ratio of microencapsulated phase change material to rubber of between about 0.5 and 2 to 1.

Preferably the dry binder to base non-woven material ratio is between about 0.3:1 and 3:1. The preferred ratio depends on the required properties of the finished product. For a cushion insole the ratio is preferably between about 0.3 and 0.5 to 1, for a lining material the ratio is preferably about 1:1 and for a stiff insole the ratio is preferably about 2.5:1.

Optionally the binder mix may include a colouring agent.

The invention further provides a method of manufacturing a shoe insole or lining material comprising the steps of:

mixing a microencapsulated phase change material comprising a material having reversible thermal energy storage properties encapsulated in microcapsules of a retaining polymer and having an activation temperature of around body temperature, with a liquid polymer binder;

impregnating a non-woven base material with the binder mixture; and

drying the impregnated material.

Preferably the method further includes the step of pre-dispersing the microencapsulated phase change material in water before mixing with the liquid polymer binder. Preferably the microencapsulated phase change material is pre-dispersed in water using a dispersing agent such as Dispex™ A40.

Preferably the method further includes the step of adding a thickening agent to the binder mix. It has been found that increasing the viscosity of the mix improves stability, reduces separation or filtering out of the microcapsules during impregnation and results in a much better appearance of the finished material.

Preferably the impregnated material is dried at about 120° C. Preferably the method includes the further step of curing the polymer binder material. Advantageously the curing step is carried out at about 140° C. Preferably the method includes the further step of finishing the material, for example by calendering the material to the required gauge, sueding the surface of the non-woven lining and the application of adhesive or barrier coatings to aid the shoe making process.

The invention farther comprises a shoe insole comprising a non-woven base material, a polymer binder, and a microencapsulated phase change material dispersed within the binder, wherein the phase change material comprises a material having reversible thermal energy storage properties encapsulated in microcapsules of a retaining polymer and the phase change material has an activation temperature of around body temperature.

Preferably the base material comprises a non-woven needle felt. Advantageously the base material has an initial thickness of between about 0.5 mm and 20 mm, depending on the intended use of the material. Preferably for a shoe insole or lining material the initial thickness is between 0.5 mm and 5 mm, whereas for a cushion insole the initial thickness is preferably between about 5 mm and 1 5 mm.

Materials and methods of manufacture in accordance with the invention will now be described, by way of example only. It will be realised that these materials and methods have been selected for description to illustrate the invention by way of example.

A problem addressed by the methods of the present invention is how to get the micro-encapsulated phase change wax incorporated into an impregnated needle felt in sufficient quantity to have a cooling effect when used in a shoe, whilst retaining the necessary quality and properties of the insole or lining material and avoiding contamination of the skin of the wearer with the hydrocarbon wax which is an irritant.

In a first example, a non-woven needle felt of a blend of polyester fibres suitable for use as a shoe insole, such as for example the felt designated T90 as manufactured by Texon UK Limited, was impregnated with a water-based latex binder. The binder comprised the following composition by weight:

| | | | |
|---|---|---|---|
| Thermasorb ™ microcapsules | 90 | ) | pre-dispersion |
| Dispex ™ A40 | 0.9 | ) | solid content |
| Water | 109 | ) | of 45% |
| Applied Polymers S30R | 100 | | |
| Synthomer ™ 7050 | 33 | | |
| Colouring agent | 15 | | |
| Ammonia | 1.5 | | |
| 10% Viscalex ™ HV30 | 25 | | |

This gives a Thermasorb™ to rubber content of 1.25:1 and a solids content of 43.2%.

A mat of polyester needle felt 40 cm×14 cm and having a thickness of 4.0 mm was impregnated with the binder mixture with a ratio of dry binder to felt of 1.70:1. The resulting impregnated material was dried at 120° C. and cured at 140° C. The final material had a weight of 1850 gsm and gauge of 4.2 mm and a Thermasorb™ content of 22% or 400 gsm. This material could provide an energy storage capability of about 49 to 50 joules per gramme, which can provide a cooling or warming effect when used as a shoe insole.

In a second example, a non-woven needle felt of coarse polyester fibres suitable for use as a cushion insole for a shoe, such as for example the felt designated T100 as manufactured by Texon UK Limited, was impregnated with a water-based latex binder. The binder comprised the following composition by weight:

| | | | |
|---|---|---|---|
| Thermasorb ™ microcapsules | 90 | ) | pre-dispersion |
| Dispex ™ A40 | 0.9 | ) | solid content |
| Water | 109 | ) | of 45% |
| Latex 2890 | 200 | | |
| Colouring agent | 15 | | |
| Ammonia | 1.5 | | |
| 10% Viscalex ™ HV30 | 25 | | |

Latex 2890 is a Perbunan™ nitrile rubber latex available from Bayer.

The second example gives a Thermasorb™ to rubber content of 1.13:1 and a solids content of 38.5%.

A mat of felt 40 cm×14 cm and having a thickness of 4.0 mm was impregnated with the binder mixture with a ratio of dry binder to felt of 1.50:1. The resulting impregnated material was dried at 120° C. and cured are 140° C. The final material had a weight of 900 gsm and gauge of 4.0 mm and a Thermasorb™ content of 23% or 200 gsm. This material could provide an energy storage capability of about 57 to 58 joules per gramme, which can provide a cooling or warming effect when used as a shoe insole.

Test results indicate that the shoe insole and lining materials according to the invention provide a noticeable cooling or warming effect when used within a shoe.

In use, the phase change material incorporated in the shoe insole or lining material enables feet to be kept cool in an enclosed shoe in hot or active situations. As the material heats up, the phase change material melts and removes heat from the foot. When in the melted state, the hydrocarbon wax of the phase change material is a liquid and a potential irritant to human skin. The encapsulation of the wax in tiny bubbles of retaining polymer safely encloses the phase change material. These microcapsules are incorporated into impregnated non-woven insoles or linings by dispersing them within the liquid impregnant binder system prior to impregnation. The materials are then dried and finished as normal.

The resulting insole or lining material may then be incorporated into a shoe, where it will perform as a latent heat storage system for the heat produced by the foot, so helping to keep the foot cooler than with similar materials without the phase change material incorporated therein.

Whereas the illustrative materials and methods primarily relate to provision of cooling of feet, materials in accordance with the invention may be manufactured such that the phase change activation temperature is appropriate to warm the foot of a wearer, in cold conditions, rather than to cool the foot.

1. A shoe insole or lining material comprising:
a non-woven base material;
a polymer binder applied in liquid form and then solidified; and
a microencapsulated phase change material dispersed within the binder, wherein the phase change material comprises a material having reversible thermal energy storage properties encapsulated in microcapsules of a retaining polymer and the phase change material has an activation temperature of around body temperature.

2. A shoe insole or lining material according to claim 1 wherein the base material comprises a non-woven needle felt.

3. A shoe insole or lining material according to claim 1 wherein the binder comprises a latex binder.

4 . A shoe insole or lining material according to claim 3 wherein the latex binder comprises a water based latex blend.

5. A shoe insole or lining material according to claim 3 wherein the latex binder comprises a stiff styrene butadiene rubber latex.

6. A shoe insole or lining material according to claim 1 wherein the binder includes a thickener.

7. A shoe insole or lining material according to claim 6 wherein the thickener comprises ammonia and an acrylic latex that reacts with the ammonia to thicken the mixture.

8. A shoe insole or lining material according to claim 1 wherein the phase change material comprises hydrocarbon wax or paraffinic hydrocarbon encapsulated in polymer.

9. A shoe insole or lining material according to claim 8 wherein the polymer capsules have a diameter of approximately 15 to 25 μm.

10. A shoe insole or lining material according to claim 1 wherein the melting point or activation temperature of the phase change material is in the range 15 to 55° C.

11. A shoe insole or lining material according to claim 10 wherein the melting point or activation temperature of the phase change material is in the range 26 to 38° C.

12. A shoe insole or lining material according to claim 11 wherein the activation temperature is about 28° C.

13. A shoe insole or lining material according to claim 1 wherein the phase change material is predispersed in water using a dispersing agent before being mixed with the binder.

14. A shoe insole or lining material according to claim 13 wherein the phase change material is dispersed in the water at between about 30% and 60% by weight of solid material to water.

15. A shoe insole or lining material according to claim 14 wherein the phase change material is dispersed in the water at between 40% and 45%.

16. A shoe insole or lining material according to claim 13 wherein the water/microencapsulated phase change material mixture is mixed with the binder to give a ratio of microencapsulated phase change material to binder solids of between about 0.5 and 2 to 1.

17. A shoe insole or lining material according claim 1 wherein the dry binder to base material ratio is between about 0.3:1 and 3:1.

18. A shoe insole or lining material according to claim 1 wherein the binder mix further includes a colouring agent.

19. A method of manufacturing a shoe insole or lining material comprising the steps of:
mixing a microencapsulated phase change material comprising a material having reversible thermal energy storage properties encapsulated in microcapsules of a retaining polymer and having an activation temperature of around body temperature, with a liquid polymer binder;
impregnating a non-woven base material with the binder mixture; and
drying the impregnated material.

20. A method according to claim 19 further including the step of pre-dispersing the microencapsulated phase change material in water before mixing with the liquid polymer binder.

21. A method according to claim 20 wherein the microencapsulated phase change material is pre-dispersed in water using a dispersing agent.

22. A method according to claim 19 further including the step of adding a thickening agent to the binder mix.

23. A method according to claim 19 further including the step of drying the impregnated material at about 120° C.

24. A method according to claim 19 further including the step of curing the material.

25. A method according to claim 19 further including the step of finishing the material.

26. A shoe insole comprising a non-woven base material, a polymer binder and a microencapsulated a phase change material dispersed within the binder, wherein the phase change material comprises a material having reversible thermal energy storage properties encapsulated in microcapsules of a retaining polymer and the phase change material has an activation temperature of around body temperature.

27. A shoe insole according to claim 26 wherein the base material comprises a non-woven needle felt.

28. A shoe insole according to claim 27 wherein the base material has an initial thickness of between 0.5 mm and 20 mm.
